(19) United States
(12) Patent Application Publication
(10) Pub. No.: US 2017/0355879 A1
(43) Pub. Date: Dec. 14, 2017

(54) HYDROPHOBIC COATINGS (AS AMENDED)

(71) Applicant: AGENCY FOR SCIENCE, TECHNOLOGY AND RESEARCH, Singapore (SG)

(72) Inventors: Hong YAN, Singapore (SG); Jianwei XU, Singapore (SG); Qun YE, Singapore (SG); Hui ZHOU, Singapore (SG)

(21) Appl. No.: 15/526,743

(22) PCT Filed: Nov. 16, 2015
(86) PCT No.: PCT/SG2015/050451

§ 371 Date: May 12, 2017

(30) Foreign Application Priority Data
Nov. 14, 2014 (SG) 10201407612Y

(51) Int. Cl. C09D 183/10; C08G 83/00; B05D 5/08; B05D 1/18

(52) U.S. Cl. CPC C09D 183/10; B05D 5/08; C08G 83/001; B05D 1/18

(57) ABSTRACT

A hydrophobic or superhydrophobic polymer composite comprising a lattice of poiycyclic aromatic hydrocarbons such as reduced graphene oxide (rGO) modified with at least one siloxane polymer and a method of preparation thereof is disclosed. A method of coating a material comprising immersing a material in a coating solution made from the rGO and siloxane polymer is also disclosed.

### PRIORITY CLAIM

The present application claims priority to Singapore patent application number 10201407612Y filed at the Intellectual Property Office of Singapore on 14 Nov. 2014.

### TECHNICAL FIELD

The present invention relates to hydrophobic or superhydrophobic coatings. In addition, it relates to coating compositions for preparing such coatings and methods of obtaining such coating compositions.

### BACKGROUND ART

Surface materials or coatings which express water contact angles greater than 90 degrees are generally considered hydrophobic while those showing an angle of greater than 150 degrees are considered superhydrophobic.

Superhydrophobic coatings are potentially useful in many industrial applications, e.g., increasing efficiency of heat transfer. The use of hydrophobic surfaces has been shown to increase the total efficiency in steam power plant by a total of 4%. Superhydrophobic coatings can be achieved by using perfluorinated materials or by creating a surface having special morphology or hierarchical patterning. For instance, cotton fabrics have been coated with zinc oxide nanorods or zinc oxide crystallites to provide superhydrophobic surfaces. In other examples, fibers have been coated with silicone filaments to create a water-repellent clothing material. In other examples, a superamphiphobic fabric was achieved through a two-step wet-chemistry coating technique, which exhibited remarkable multi-self-healing ability against physical and chemical damage and exceptional liquid-repellency to low surface-tension liquids such as ethanol.

However, some challenges remain in the replicability of the superhydrophobic properties, abrasion resistance of the coating, safety of materials used, as well as the need to maintain long-term superhydrophobicity while maintaining chemical, acid and alkaline resistance. In addition, preparing superhydrophobic coatings in a cost-effective way is another practical concern that needs to be addressed.

Polydimethylsiloxane (PDMS) have shown great promise in a wide range of applications due to its properties of being thermally stable, water repellent, resistance to oxygen, ozone and UV-light, and its general environmental benignity. To date, various PDMS hybrid materials have been employed as hydrophobic paints for applications in surface coating. PDMS based composites have also been used for fabric treatment, which can endow the fabrics with superhydrophobicity. For example, one study reported self-healing superhydrophobic fabrics through a combination coating comprising fluoro-containing polymer, fluoroalkyl silane, and modified silica nanocomposites. The coating not only granted the fabric water repellency, but also demonstrated durability against washing and abrasion. Nevertheless, the integration of the costly fluoro-containing components or nanocomposites into coating solution limits its practical applications.

Coating textile fabrics with silicone-based coating materials are also known. Fabric coated with silicone-based materials may exhibit improved mechanical properties (e.g. tear strength, puncture resistance and tensile strength), thus allowing reductions in the mass and thickness of coated fabrics, which are particularly useful in the construction of airbags for automotive application. Such silicone coatings typically contain at least one perfluoroalkyl compound and may require curing via application of heat or ultra violet radiation after being applied on the fabric surface. Again, a drawback of such coating materials is the requirement of a substantial amount of fluoro-polymer and modified silica nanocomposites.

The advantage of hybridization polymers, particularly fluoro-polymers hybridized with other functional molecules and nanostructured materials for fabric coatings is that the as-prepared coating materials offer, in addition to hydrophobicity, additional benefits originating from the integration of the other functional molecules and inorganic nanostructured materials with hydrophobic polymers, e.g. magnetic properties. This makes such coating materials suitable for a variety of applications in the areas of packaging materials, paper industry, cotton fabrics and cellulose membranes.

However, hybridization methods face two main challenges: the low reactivity of a polymer matrix, e.g., PDMS, for further modification or functionalization, and the difficulty in achieving a homogeneous dispersion due to the low compatibility between the oily PDMS and solid nanostructured materials. Moreover, the interfacial adhesion between organic and inorganic phases is a significant element in controlling the structure and properties of coating materials.

Accordingly, it is an object of the present invention to provide a easy to fabricate, cost-effective hydrophobic coating composition. In particular, it is desired to provide a coating composition that is readily dispersible in an organic solvent without experiencing phase separation. More particularly, it is also desired to provide a hydrophobic coating that does not require the use of fluorinated or perfluorinated polymers which may be cost-prohibitive to employ on a large industrial scale.

Other desirable features and characteristics will become apparent from the subsequent detailed description and the appended claims, taken in conjunction with the accompanying drawings and this background of the disclosure.

### SUMMARY

In one aspect of the present invention, there is provided a polymer composite comprising a lattice of polycyclic aromatic hydrocarbons modified with at least one siloxane polymer.

In one embodiment, the polymer composite comprises a plurality of cross-linked polysiloxane polymer chains, wherein said plurality of polysiloxane polymer chains are crosslinked by at least one polycyclic aromatic hydrocarbon.

The polycyclic aromatic hydrocarbon may comprise a two-dimensional lattice structure, for instance, a planar structure that is a single-atom thick. The lattice structure may comprise a plurality of bonded or fused polygonal carbon rings. The carbon rings may be heterocyclic or may consist solely of carbon atoms at each ring vertex.

In one embodiment, the polycyclic aromatic hydrocarbon may comprise a honey-combed shaped lattice. For example, the polycylic aromatic hydrocarbon may be graphene comprising one or more unsaturated carbon-carbon bonds. For example, the polycyclic structure may be derived from graphene oxide, e.g., by thermal or chemical reduction of graphene oxide. In one embodiment, the polycyclic lattice structure may be reduced graphene oxide.

Advantageously, it has been found that the addition of the disclosed polycyclic aromatic hydrocarbon lattice to a polysiloxane results in a polymer composite that can be used in the preparation of a hydrophobic coating composition. Such a coating composition, when applied as a coating, advantageously provides durable hydrophobicity or superhydrophobicity, while exhibiting stable, long term resistance to acid, alkaline and water. Advantageously, the observed hydrophobicity is comparable if not superior to that provided by conventional fluorinated silicone polymers. Advantageously, the disclosed polymer composite provides a viable, cost-effective alternative to known hydrophobic materials for use in preparing hydrophobic coatings.

Advantageously, it has been surprisingly found that the a polysiloxane mixed with only 1 weight % or less of the disclosed polycyclic aromatic hydrocarbon is sufficient for providing a superhydrophobic coating wherein the water contact angle (“WCA”) is 150° or greater. Unless otherwise specified, the weight percentage refers to the mass of the polycyclic aromatic hydrocarbon as a fraction of the total mass of the polysiloxane.

In another aspect, there is provided a method for forming a polymer composite, comprising a step of reacting a lattice of polycyclic aromatic hydrocarbons with at least one siloxane polymer. The reaction may also be termed as hydrosilylation. The polycyclic aromatic hydrocarbon may be modified with reactive functional groups prior to the hydrosilylation reaction. The reactive functional group may be one that is reactive with a silicon hydride group to thereby covalently couple the polycyclic aromatic hydrocarbon lattice to the siloxane polymer matrix during the hydrosilylation reaction. In one embodiment, the modified polycyclic aromatic hydrocarbon acts as a cross-linker to thereby covalently couple two or more polymer chains to form a cross-linked network of polysiloxane polymer chains.

In another aspect, there is provided the use of a polymer composite as defined above as a coating composition. In embodiments, the polymer composite may be provided in solution form by dispersing the polymer composite in one or more organic solvents.

In yet another aspect, there is provided a method of coating a material, comprising the steps of: (a) dissolving a polymer composite comprising a lattice of polycyclic aromatic hydrocarbons modified with at least one siloxane polymer in a solvent to form a coating solution; (b) immersing said material in the coating solution; and (c) removing said material from the coating solution.

### BRIEF DESCRIPTION OF DRAWINGS

The accompanying figures serve to illustrate various embodiments and to explain various principles and advantages in accordance with a present embodiment.

FIG. 1 is a schematic representation showing two synthesis routes of the disclosed polymer composite; Approach I shows the preparation of a trimethylsily terminated PDMS/PMHS [“Poly(dimethylsiloxane-co-methylhydrosiloxane)”] and RGO polymer composite wherein the PMHS is present in an amount of 3-4 mol %; Approach II shows the reaction of a Si—H terminated PDMS with RGO through hydrosilylation to form another variant of the disclosed polymer composite.

FIG. 2 depicts a Fourier Transform Infrared Spectroscopy (FTIR) spectra of (a) PDMS/PMHS (MW 13000), (b) PDMS/PMHS@RGO 1 (1 gram PDMS; 1 mL vinyloxy modified RGO solution), (c) PDMS/PMHS@RGO 2 (1 gram PDMS; 2 mL vinyloxy modified RGO solution), (d) PDMS/PMHS@RGO 3 (1 gram PDMS; 5 mL vinyloxy modified RGO solution), (e) PDMS/PMHS@RGO 4 (1 gram PDMS; 10 mL vinyloxy modified RGO solution).

FIG. 3 depicts a FTIR spectra of (a) vinyloxy benzene covered RGO, (b) PDMS@RGO 6 (100 mg Si—H terminated PDMS, MW: 600-800; 10 mL vinyloxy modified RGO), (c) PDMS@RGO 7 (100 mg Si—H terminated PDMS, MW: 4500-5000, 10 mL vinyloxy modified RGO).

FIG. 4 shows the UV-visible spectra obtained from solutions of (A) different PDMS/PMHS@RGO 1˜4 in chloroform and (B) vinyloxy benzene covered RGO, PDMS and PDMS@RGO 6˜7 in toluene.

FIG. 5 depicts the viscosity changes of PDMS/PMHS@RGO hybrid materials 1˜4 containing different amount (wt %) of RGO at room temperature.

FIG. 6A shows the wetting behavior of water on the different treatment fabrics (a) to (f). Top panel: photographs of blue-colored water droplets on the fabrics. Bottom panel: Optical images of static water droplets on the fabrics (10 μL for each drop). (a) un-coated; (b) PDMS/PMHS coated; (c) coated with PDMS/PMHS@RGO 1; (d) coated with PDMS/PMHS@RGO 2; (e) coated with PDMS/PMHS@RGO 3; (f) coated with PDMS/PMHS@RGO 4; (g) coated with PDMS@RGO 6; (h) coated with PDMS@RGO 7.

FIG. 6B contains SEM images of an un-coated fabric.

FIG. 6C contains SEM images of a fabric dip-coated with PDMS/PMHS@RGO 3.

FIG. 6D contains SEM images of a fabric dip-coated with PDMS@RGO 7.

FIG. 6E, 6F contains photographs of uncoated and PDMS/PMHS@RGO 3 coated fiber tissue after being dipped in blue water and rinsed with water at room temperature.

FIG. 7 is a schematic representation of (A) spin-coating of PDMS/PMHS@RGO hybrid materials on a glass slide; (B) superhydrophobic fabric-coating of PDMS/PMHS@RGO hybrid materials with hierarchical roughness; and (C) Linear PDMS/PMHS modified with RGO on fiber.

FIG. 8 shows the wetting behavior for fabrics coated with polymer composites of the present invention after undergoing various chemical and heat treatment. Column 1 shows the effects after acid etching (2 hours; aqueous H₂SO₄ solution; pH=1); Column 2 shows the effects after base etching (2 hours aqueous NaOH solution; pH=14); and Column 3 shows the effects after boiling water (2 hours).

FIG. 9 shows the water contact angles of PDMS/PMHS@RGO 3 coated textile fibers changes with various etching time periods in (A) an aqueous H₂SO₄ solution (pH=1), (B) an aqueous KOH solution (pH=14), and (C) with various washing time periods (the coated textile fibers were stirred in 500 mL water using an egg shaped stirring bar, TEFLON®, 3/4×1⅝ in, 900 rpm).

### DESCRIPTION OF EMBODIMENTS

The following detailed description is merely exemplary in nature and is not intended to limit the invention or the application and uses of the invention. Furthermore, there is no intention to be bound by any theory presented in the preceding background of the invention or the following detailed description. Herein, a polymer composite is presented in accordance with present embodiments.

In one embodiment, the present disclosure relates to a polymer composite comprising a lattice of polycyclic aromatic hydrocarbons modified with at least one siloxane polymer. In the present specification, the term “modified” when applied to the disclosed polymer composite includes chemical bonding via a cross-linker group.

Prior to bonding with the siloxane polymer, the polycyclic aromatic hydrocarbon lattice may be surface functionalized with an unsaturated functional group, e.g., an alkenyl group. This functionalization In some embodiments, the lattice of polycyclic aromatic hydrocarbons may be functionalized with an alkenyloxy alkyl or an aryl substituted with an alkenyloxy or an alkenyl. The alkenyloxy alkyl may be vinyloxy alkyl. The alkenyloxy aryl may be vinyloxy benzyl.

In embodiments, the disclosed polymer composite may comprise a plurality of polysiloxane polymer chains coupled to the polycyclic aromatic hydrocarbon lattice via an aryloxy or an alkoxy linker group.

In embodiments, the polycyclic aromatic hydrocarbon lattice is derived from graphene oxide. For instance, the polycyclic aromatic hydrocarbon lattice may be a reduced graphene oxide (RGO). The RGO may be thermally reduced graphene oxide or chemically reduced graphene oxide. The RGO may be functionalized with one or more reactive functional groups capable or forming a covalent bond with a Si—H group (“functionalized RGO”). Such functional groups may include an unsaturated aliphatic linker group. In one embodiment, the RGO is functionalized with an alkenyloxy aryl, for instance, vinyloxy benzene. The functionalized RGO may be dissolved in solution using an organic solvent, such as toluene, DMF, DMSO, acetone, etc.

The siloxane polymer may be an organopolysiloxane polymer. The organopolysiloxane polymer may comprise hydrophobic groups. The hydrophobic groups may be selected from alkyl or aryl. The hydrophobic alkyl group may be a C₁₋₁₀-alkyl. Hence, the alkyl may be methyl, ethyl, propyl, butyl, pentyl, hexyl, heptyl, octyl, nonyl or decyl, including isomers thereof. The alkyl may be a straight-chained or branched alkyl. The hydrophobic aryl group may be a monovalent (“aryl”) and divalent (“arylene”) single, polynuclear, conjugated and fused residues of aromatic hydrocarbons having from 6 to 10 carbon atoms. Examples of such groups include phenyl, biphenyl, naphthyl, phenanthrenyl, and the like.

The organopolysiloxane polymer may have the following formula (I):

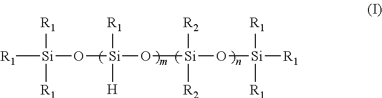

wherein
R₁, at each occurrence, is independently selected from hydrogen, an alkyl, an aryl or an alkylaryl;
R₂ is an alkyl;
m is 0 or an integer from 5 to 100; and
n is 0 or an integer from 9 to 500.

In formula (I), m and n are not concurrently 0.

The alkyl group as defined in R₁ or R₂ may be a C₁₋₁₀-alkyl. Hence, the alkyl may be methyl, ethyl, propyl, butyl, pentyl, hexyl, heptyl, octyl, nonyl or decyl, including isomers thereof. The alkyl may be a straight-chained or branched alkyl.

In embodiments, both R₁ and R₂ are methyl groups. Where m=0, at least one R₁ at each of the terminus of the polymer is hydrogen, i.e., a Si—H terminated PDMS. When n=0, each of the terminal R₁ groups may be an alkyl group, e.g., a methyl group.

The aryl group as defined in R₁ may be a monovalent (“aryl”) and divalent (“arylene”) single, polynuclear, conjugated and fused residues of aromatic hydrocarbons having from 6 to 10 carbon atoms. Examples of such groups include phenyl, biphenyl, naphthyl, phenanthrenyl, and the like.

The alkylaryl group as defined in R₁ includes alkyl and aryl groups as defined above, and is represented by the bonding arrangement present in a benzyl group.

In formula (I), when m is 0, the organopolysiloxane polymer may be polydimethylsiloxane. The polydimethylsiloxane may be a Si—H terminated polydimethylsiloxane, wherein the terminal Si—H groups are capable of bonding with the disclosed functionalized polycyclic hydrocarbons. For instance, the Si—H group may react with the alkenyl groups on the reduced graphene oxide (RGO) to thereby form a polymer composite wherein the PDMS polymer backbone is oriented in a substantially perpendicular manner relative to the planar lattice RGO structure. The Si—H terminated PDMS may have an average molecular weight of around 400-5000. In embodiments, the Si—H terminated PDMS may have an average molecular weight of around 400 to 600, 400 to 700, 400 to 800, 400 to 900, 400-1000, 600 to 800, 600 to 900, or 600 to 1,000. In other embodiments, the Si—H terminated PDMS may have an average molecular weight of around 4000-4200, 4000-4,400, 4,000-4,500, 4000-4,600, 4,000-4,800, 4,000-5,000, 4,500-4,700, 4500-4,900, or 4,500-5,000.

In embodiments, each occurrence of the reactive alkenyl group on the functionalized RGO may act as a reactive site for bonding with at least one Si—H group present in the polysiloxane polymer. Where m is 0 and the polysiloxane is Si—H terminated PDMS, the RGO lattice may have one or more PDMS polymer chains extending in a normal orientation from its planar surface.

When m is not 0 (that is, m is an integer), the organopolysiloxane polymer may be a copolymer such as poly(dimethylsiloxane-co-methylhydrosiloxane). In the context of the present specification, this co-polymer is also abbreviated as PDMS/PHMS. Here, the poly(dimethylsiloxane-co-methylhydrosiloxane) may be trimethylsilyl terminated. The dimethylsiloxane monomers and the methylhydrosiloxane monomers may form a block PDMS/PHMS copolymer or a statistical PDMS/PHMS copolymer.

The trimethylsilyl terminated poly(dimethylsiloxane-co-methylhydrosiloxane) may have an average Mn of about 950, wherein the methylhydrosiloxane monomer unit is present in an amount of about 1 to about 50 mol %, 1 to about 40 mol %, 1 to about 30 mol %, 1 to about 20 mol %, and 1 to about 10 mol %. The methylhydrosiloxane monomer unit may be present in about 1 mol %, 2 mol %, 3 mol %, 4 mol %, 5 mol %, 6 mol %, 7 mol %, 8 mol %, 9 mol %, 10 mol %, 11 mol %, 12 mol %, 13 mol %, 14 mol %, or 15 mol % based on the total monomer units of the PDMS/PHMS co-polymer. In one embodiment, the methylhydrosiloxane monomer unit may be present in about 2 to 5 or 3 to 4 mol %.

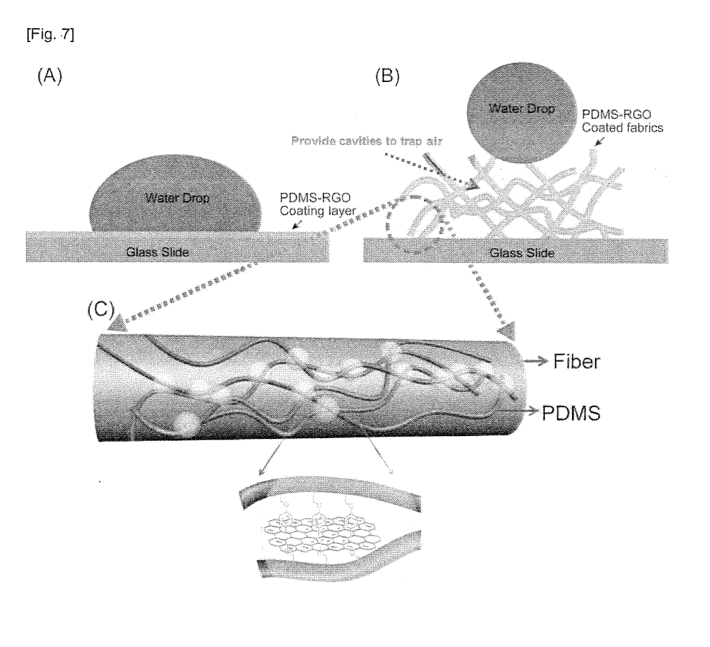

Each methylhydrosiloxane monomer unit contains at least one Si—H group that is capable of bonding with an unsaturated or vinyl functional group present on the functionalized reduced graphene oxide. Under this reaction approach, the PDMS/PHMS copolymer may be oriented in a substantially parallel manner relative to the planar RGO lattice structure (See FIG. 7C). Advantageously, the functionalized RGO may act as a cross-linking node by chemically coupling at least two or more copolymer strands.

The PDMS/PHMS copolymer may have an average molecular weight of around 10,000 to 16,000, for example, around 10,000 to 15,000, 10,000 to 14,000, 10,000 to 13,000, 10,000 to 12,000, 11,000 to 16,000, 11,000 to 15,000, 11,000 to 14,000, 11,000 to 13,000, 11,000 to 12,000, 12,000 to 16,000, 12,000 to 15,000, 12,000 to 14,000, 12,000-13,000, 13,000 to 16,000, 13,000 to 15,000, 13,000 to 14,000, 14,000 to 16,000, 14,000 to 15,000, or 15,000 to 16,000.

In formula (I), where n is 0, the organopolysiloxane polymer may be poly(methylhydrosiloxane) (PMHS). The poly(methylhydrosiloxane) may have an average Mn of about 390 or having a range of about 1,700 to about 3,200.

In other embodiments, the organopolysiloxane polymer may have a molecular weight of more than 800. The molecular weight of the organopolysiloxane polymer may range from more than 800 to about 15,000. The molecular weight of the organopolysiloxane polymer may be about 4500, about 5000 or about 13,000.

The weight ratio of the organopolysiloxane polymer to the reduced graphene oxide may be in the range of about 20:1 to about 4000:1 (i.e., 5 wt % to about 0.025 wt %). The weight ratio of the polysiloxane polymer to the RGO may also be in a range of from about 200:1 to about 3,800:1.

In particular embodiments, the weight ratio may be about 20:1, about 194:1, about 388:1, about 776:1, about 1940:1 or about 3800:1.

In embodiments, the weight percentage of the RGO as a fraction of the total mass of the polysiloxane polymer may be from about 0.01-1 wt %, 0.01-0.9 wt %, 0.01-0.8 wt %, 0.01 to 0.7 wt %, 0.01 to 0.6 wt %, 0.01 to 0.5 wt %, 0.01 to 0.4 wt %, 0.01 to 0.3 wt %, 0.01 to 0.25 wt %, 0.01 to 0.2 wt %, 0.02 to 1 wt %, 0.02 to 0.9 wt %, 0.02 to 0.8 wt %, 0.02 to 0.7 wt %, 0.02 to 0.6 wt %, 0.02 to 0.5 wt %, 0.02 to 0.4 wt %, 0.02 to 0.3 wt %, 0.02 to 0.25 wt %, or 0.02 to 0.2 wt %. In certain embodiments, the weight percentage of functionalized RGO may be from about 0.026-0.26 wt %.

Another embodiment relates to a method for forming a polymer composite, comprising the step of reacting a lattice of polycyclic aromatic hydrocarbons with at least one siloxane polymer. The reaction may be termed as hydrosilylation, wherein a Si—H group is reacted with an unsaturated bond. In order for the hydrosilylation reaction to occur, the method may comprise the step of surface functionalizing the lattice of polycyclic aromatic hydrocarbons with at least one reactive unsaturated group that is capable of forming a covalent bond with a Si—H functional group.

In embodiments, the polycyclic aromatic hydrocarbon lattice is a RGO lattice and the surface functionalization step comprises reacting the RGO lattice with a alkenylation agent. The alkenylating agent may be a vinyloxy aryl fluoroborate. In one embodiment, the alkenylating agent is 4-vinylbenzenediazonium tetrafluoroborate.

The hydrosilylation reaction may be undertaken in the presence of a catalyst. The catalyst may be a metal-containing catalyst comprising a metal selected from Groups 8, 9 or 10 of the Periodic Table of Elements. The catalyst may be a metal complex, such as a platinum, rhodium or ruthenium metal complex. In embodiments, the platinum catalyst may be selected from H₂PtCl₆ or Pt₂[(Me₂SiCH═CH₂)₂O]₃. The rhodium catalyst may be [Rh(cod)₂]BF₄, [Rh(nbd)Cl]₂ or RhCl(PPh3)3 (Ph=phenyl). The ruthenium catalyst may be [Ru(η^{e}-arene)Cl₂]₂ or C₄₃H₇₂Cl₂P₂Ru (Grubb's first generation catalyst).

In the reacting step, the weight % of the reduced graphene oxide may be in the range of 0.02% to 0.3% (based on the weight of the siloxane polymer). In other embodiments, the weight percentage of the RGO may be provided in a weight percentage of from about 0.01-1 wt %, 0.01-0.9 wt %, 0.01-0.8 wt %, 0.01 to 0.7 wt %, 0.01 to 0.6 wt %, 0.01 to 0.5 wt %, 0.01 to 0.4 wt %, 0.01 to 0.3 wt %, 0.01 to 0.25 wt %, 0.01 to 0.2 wt %, 0.02 to 1 wt %, 0.02 to 0.9 wt %, 0.02 to 0.8 wt %, 0.02 to 0.7 wt %, 0.02 to 0.6 wt %, 0.02 to 0.5 wt %, 0.02 to 0.4 wt %, 0.02 to 0.3 wt %, 0.02 to 0.25 wt %, or 0.02 to 0.2 wt % based on the mass of the polysiloxane polymer. In certain embodiments, the weight percentage of functionalized RGO may be from about 0.026-0.26 wt %.

The reacting step may be undertaken in an inert atmosphere, such as in a nitrogen atmosphere. The method may be termed as a “one-pot” method for the synthesis of the polymer composite.

The hydrosilylation reaction may be undertaken in the presence of a solvent for both the polysiloxane polymer and the functionalized RGO. The solvent used may depend on the type of siloxane polymer used. In non-limiting examples, the solvent may be selected from the group consisting of acetone, toluene, dimethylcarbonate (DMC), dimethylsulfoxide (DMSO), dimethylformamide (DMF), dichloromethane, chloroform and mixtures thereof.

The method may further comprise a step of removing any unreacted polymers, salts or other unreacted components after the reaction step by washing the reaction products with deionized water.

After the application of the polymer composite as a coating on a material (e.g., a fabric), the coated material may be dried to remove the solvent to thereby dispose a coating thereon.

In another embodiment, the present disclosure relates to a material that has been coated with a coating composition comprising the disclosed polymer composite. In order to determine the hydrophobic properties of the coated material, a water droplet may be placed on the surface of the polymer composite coated material and the contact angle between the water droplet and the surface of the polymer composite coated material measured. The contact angle of the water droplet placed on the coated material may be more than 90°, more than 145° or more than 150°. Where the contact angle is more than 145° or more than 150°, the polymer composite coated material may be regarded as having superhydrophobic properties.

Without being bound by theory, it is also thought that the spatial arrangement of the cross-linked polymer chains on the coated surface leads to the formation of a hierarchical nanostructure or microstructure which in turn contributes to the improved hydrophobicity of the coated material. The presence of randomly oriented polymer chains in a densely cross-linked polymer matrix may also result in low surface energy film on substrates, which also advantageously contributes to the superhydrophobicity of the coated material.

Advantageously, it has further been found that the polymer composite coating as prepared according to the present invention may be stable or resistant to adverse environment and may retain its hydrophobicity even after prolonged exposure to highly acidic or highly alkaline environments. In addition, the polymer composite coated material may retain its hydrophobicity after exposure to heat conditions.

The polymer composite as disclosed herein may be used in a variety of applications such as in textile processing, packaging materials, paper industry, antifouling clothing, sportswear and boat sails.

### EXAMPLES

### Example 1 Preparation of 4-vinyloxybenzenediazonium tetrafluoroborate

4-(vinyloxy)aniline was prepared according to the literature reported procedures e.g., that described in Bioorganic & Medicinal Chemistry. 2012, 20, 5518-5526, the contents of which are hereby incorporated by reference. 4-Vinyloxybenzenediazonium tetrafluoroborate was prepared according to a modified procedure (J. Am. Chem. Soc. 2001, 123, 6536-6542, the contents of which are hereby incorporated by reference). A portion of nitrosonium tetrafluoborate (0.19 g, 1.61 mmol) was dissolved in acetonitrile (10 mL), and the solution was cooled to −30°. A solution of 4-(vinyloxy)aniline (0.2 g, 1.34 mmol) in acetonitrile (10 mL) was added dropwise while stirring. After complete addition, stirring was continued for 30 min at −30° and then stirred for a further 1 hour after removing cooling bath. And then 200 mL ether was poured into the resulting solution to give a precipitate. The product was collected by filtration and washed with ether.

### Example 2 Preparation of Vinyloxy-Containing RGO

RGO was prepared according to the literature reported procedure (J. Phys. Chem. C 2012, 116, 4175-4181, the contents of which are hereby incorporated by reference). RGO (5 mg) was dissolved in 30 mL DMF, and then ultrasonication for 2 hours in order to form a highly dispersed and homogeneous solution. The as-prepared 4-vinyloxy-benzenediazonium tetrafluoroborate (20 mg) dissolved in DMF solution (5 mL) was added into the RGO solution. The mixed solution was heated to 45° C. and stirred vigorously for 8 h. After the reaction, the resulting suspension was kept for further application.

### Example 3 Preparation of Vinyloxy-Containing RGO Modified PDMS/PMHS (PDMS/PMHS@RGO) by Approach I

PDMS (1 g) was dissolved in toluene, and the as-prepared vinyloxy-containing RGO solution (1 mL, 2 mL, 5 mL, 10 mL and 20 mL, respectively) was then added. Platinum(0)-1,3-divinyl-1,1,3,3-tetramethyl-disiloxane complex solution (100 μL) was dissolved in minimum toluene and added to the above solution slowly under N₂. Once the addition was complete, the mixture solution was stirred at 80° C. overnight. The solution was then concentrated to remove solvent and washed with water and acetone to give oily PDMS/PMHS@RGO samples 1-5 (see Table 1). These samples may be denoted as PDMS/PHMS@RGO 1, 2, 3 and so on.

### Example 4 Preparation of Hydride Terminated PDMS Modified RGO (PDMS@RGO) by Approaches II

Si—H terminated PDMS (100 mg, m.w. 600-800 for PDMS@RGO 6 and m.w. 4500-5000 for PDMS@RGO 7) was dissolved in toluene (5 mL), and the as-prepared vinyloxy-containing RGO solution (10 mL) was then added. Platinum(0)-1,3-divinyl-1,1,3,3-tetramethyldisiloxane complex solution (100 μL) was dissolved in minimum toluene and added to the above solution slowly under N₂. Once the addition was complete, the mixture solution was stirred at 80° C. overnight. The resulting material was filtered by a polycarbonate film (0.2 micron, 47 mm) or centrifuged, and extensively washed with deionized water and acetone in order to get rid of excess PDMS, salts, and other un-reactive components, yielding the RGO@PDMS products 6-7 (see Table 1). These samples may be denoted as PDMS@RGO 6 or 7.

TABLE 1

| Sample No. | 1 | 2 | 3 | 4 | 5 | 6 | 7 |
|---|---|---|---|---|---|---|---|
| Approach | I | I | I | I | I | II | II |
| M.W. (PDMS) | 13,000 ^{a)} | 13,000 ^{a)} | 13,000 ^{a)} | 13,000 ^{a)} | 13,000 ^{a)} | 600~800 ^{b)} | 4500~5000 ^{b)} |
| Feed Ratio ^{c)} | 3800:1 | 1940:1 | 776:1 | 388:1 | 194:1 | 20:1 | 20:1 |

^{a)} PDMS/PMHS;
^{b)} PDMS;
^{c)} Weight ratio.

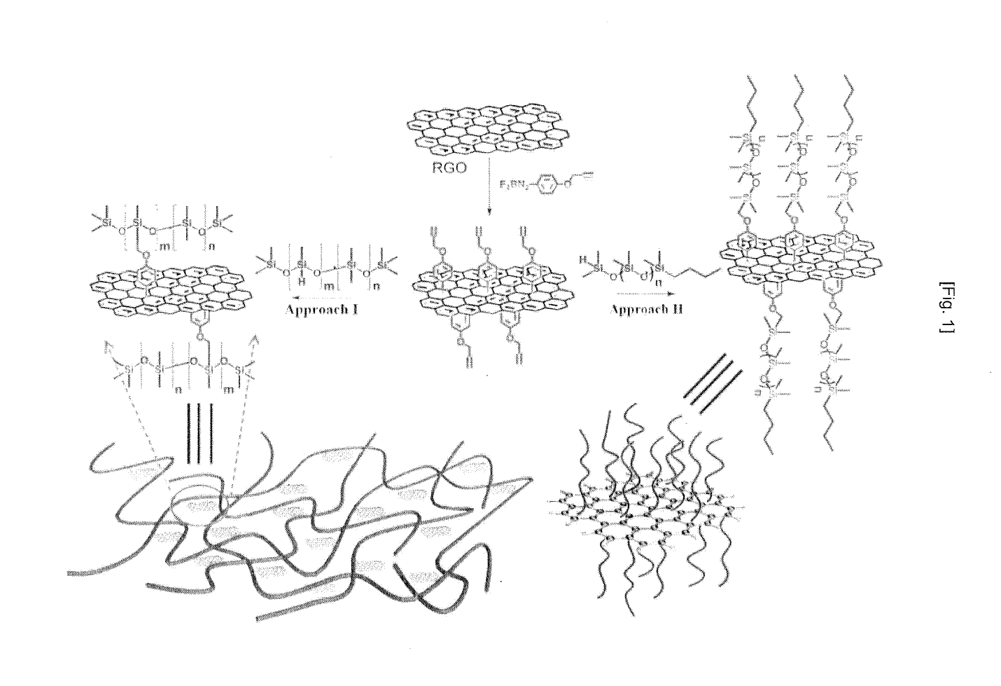

In summary, samples 1-5 were prepared based on PDMS/PHMS copolymer-RGO composites as schematically illustrated under Approach I of FIG. 1. Samples 6 and 7 were prepared based on Si—H terminated PDMS-RGO composites as schematically illustrated under Approach II. The respective weight ratios of polymer to functionalized RGO used in each of the samples are detailed in Table 1.

The RGO was coated with vinyloxy benzene through an aryl radical assisted addition reaction to the RGO surface. Afterwards, the vinyloxy benzene functionalized RGO was reacted with poly(dimethylsiloxane-co-methylhydrosiloxane) (PDMS/PMHS) or Si—H terminated poly(methylsiloxane) (PDMS) in the presence of a catalytic amount of Pt catalyst.

In the present disclosure, in order to improve the compatibility between organic and inorganic components, two types of approaches have been developed to integrate RGO and PDMS/PMHS or PDMS.

In the 1^{st} approach, manifold covalent carbon-carbon bonds were formed between PDMS/PMHS backbone and RGO surface through a one-step hydrosilylation process in DMF/toluene mixture solution. The multiple reaction sites offer a strong covalent link between nanoscale RGO building blocks and organic matrixes PDMS/PMHS, preventing phase separation in the final hybrid materials. It is noteworthy to point out that during the hydrosilylation, only a trace amount of vinyloxy benzene functionalized RGO (wt % from 0.026% to 0.26%) was required for crosslinking to assist in the formation of hybrid coating materials. The functionalized RGO also provided two-dimensional platforms to significantly improve the hydrophobicity of PDMS/PMHS matrix.

Five RGO modified PDMS/PMHS materials were designated as samples 1-5 prepared using synthesis approach I. Samples 1-4 were able to homogeneously dispersed in dichloromethane and chloroform to form stable suspensions.

In the 2^{nd} approach, the as-prepared vinyloxy benzene coated RGO was employed as a platform in which Si—H terminated PDMS can be uniformly coated on the RGO surface by a facile hydrosilylation process. And the resulting suspension was filtered through a polycarbonate film (0.2 micron, 47 mm) or centrifugation (>10000 rpm) and subsequently washed with chloroform and acetone to obtain PDMS modified RGO. Samples 6 and 7 showed good dispensability in toluene in comparison with corresponding PDMS modified RGO.

### Example 5 Preparation of Coating Solution

The above prepared samples were dissolved into chloroform and toluene, respectively in terms of their solubility. 100 μL of samples 1-4 are each dissolved into 2 mL chloroform to form respective coating solutions. A same ratio (100 μL PDMS/PMHS in 2 mL chloroform) was used to make a coating solution for comparison. The same ratio was also applied to pure PDMS for comparison. Furthermore, 2 mg of samples 6 and 7 were dispersed into 2 mL toluene to form coating solutions. After the textile fabrics immersed into the respectively prepared coating solutions, the fabrics were left at 60° in the oven for overnight to remove the solvent.

Characterization

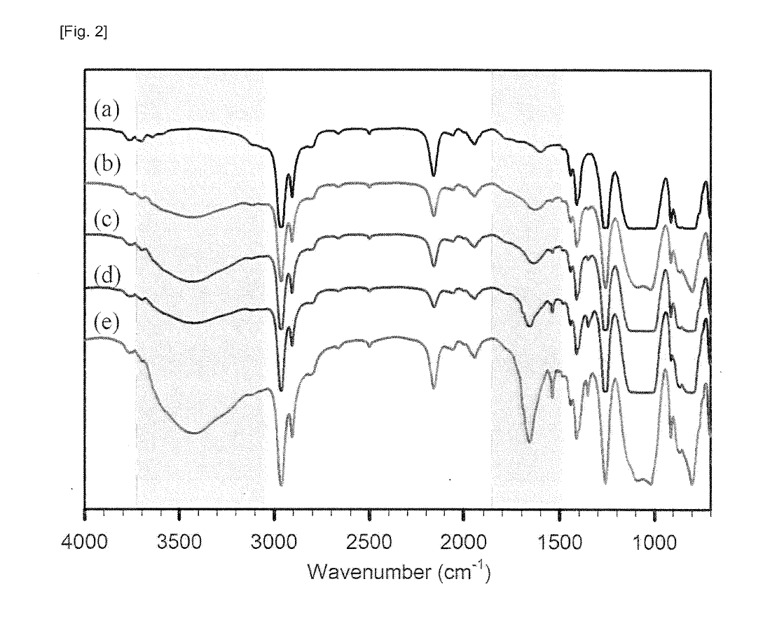

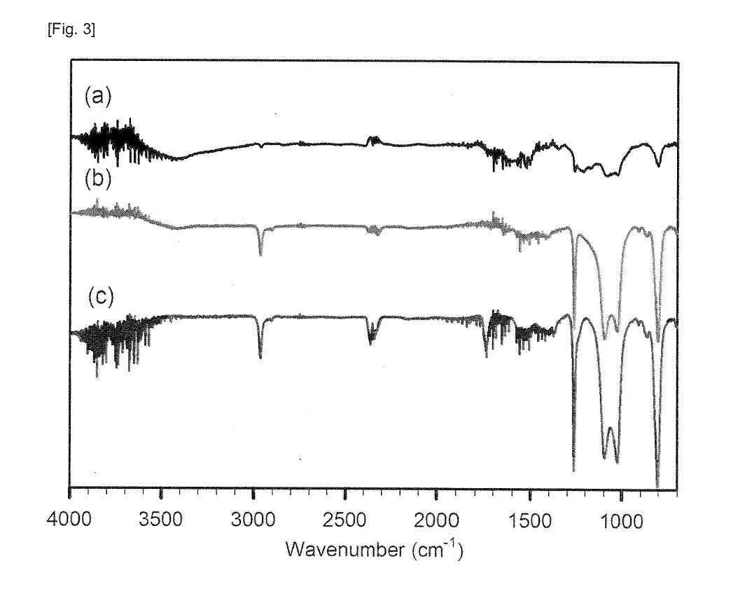

The polymer composites were characterized in terms of spectroscopic methods. FIGS. 2 and 3 show a set of representative FT-IR spectra of pure PDMS and PDMS/PMHS@RGO composites with various compositions.

All FTIR spectra of samples 1˜4 prepared by synthesis approach I show peaks around 2950, 1400 and 1260 cm⁻¹, which were assigned to Si—CH₃ groups of PDMS/PMHS. The characteristic features of their spectra showed a band of asymmetric stretching of Si—O—Si around 1100 cm⁻¹. The progressive increase in intensity of the aromatic skeletal vibration band at ˜1650 cm⁻¹ and hydroxy stretching band at ˜3100 cm⁻¹ are evident with the increase of RGO precursor in the PDMS/PMHS matrix, indicating the effective formation of covalent bonds between RGO and PDMS/PMHS.

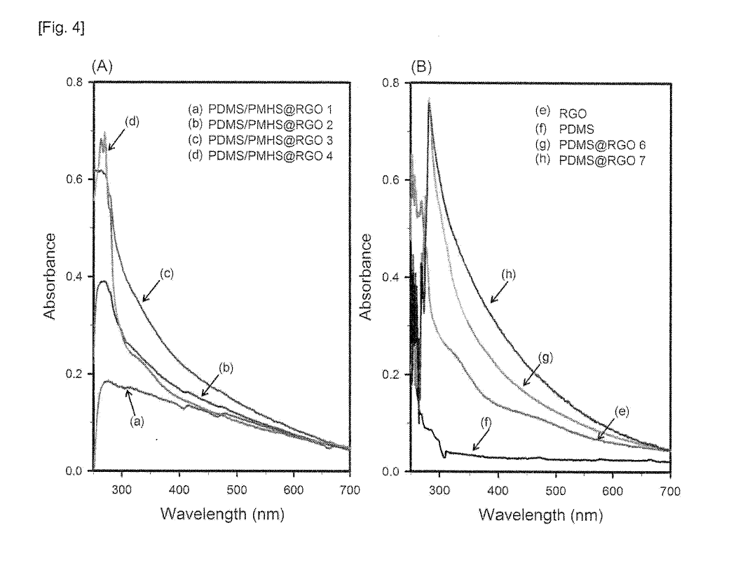

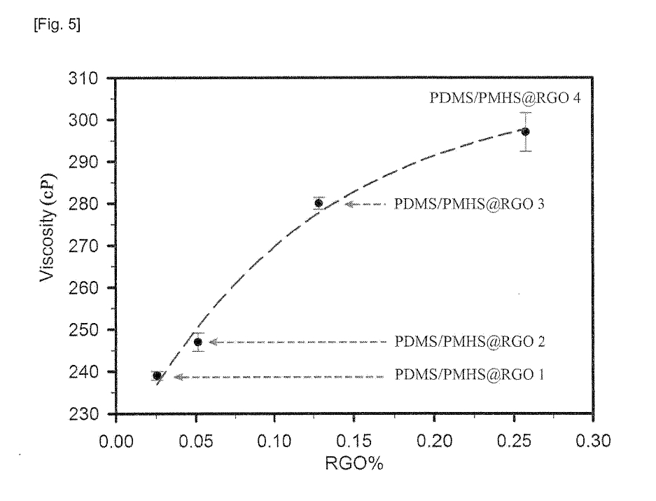

The UV-Vis spectra of PDMS/PMHS@RGO composites are shown in FIG. 4A, showing the higher the ratio of RGO precursors, the stronger the intensity of the peaks at ˜260 nm. A similar observation is found in the UV-Vis spectra of samples 6 and 7 in FIG. 4B.

The FT-IR spectra of samples 6˜7 obtained by synthesis approach II are shown in FIG. 3. The identification peaks at 2950, 1260, 1100 and 800 cm⁻¹ are observed in their respective FTIR spectrum, which corroborates the successful covalent binding between RGO and Si—H terminated PDMS.

By increasing the content of vinyloxy modified RGO to react with PDMS/PMHS matrix, gradual gelation and eventually solidification are observed in the reaction. This trend can be explained by the dense crosslinking due to the presence much more anchorage groups in the vinyloxy covered RGO in hydrosilylation reaction.

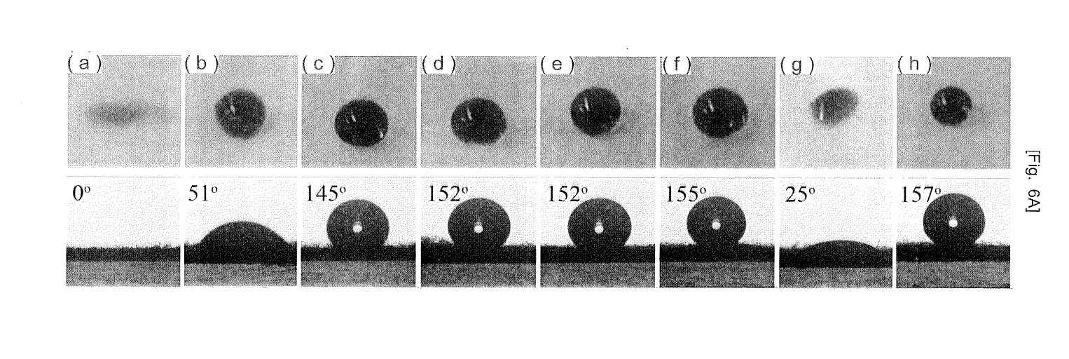

As indicated in FIG. 5, gradually increasing the amount of RGO during the hydrosilylation process, as-prepared PDMS/PMHS@RGO changes from liquid (samples 1˜3, wt % of RGO 0.026%, 0.052% and 0.129%, respectively) to gel (sample 4, wt % of RGO 0.258%) and finally to solid state (sample 5, wt % of RGO 0.515%). This is also evidenced by the increase of viscosity with the increase of RGO.

In addition, Samples 1˜4 could be homogeneously dispersed in chloroform. However, sample 5 cannot be fully dispersed in chloroform.

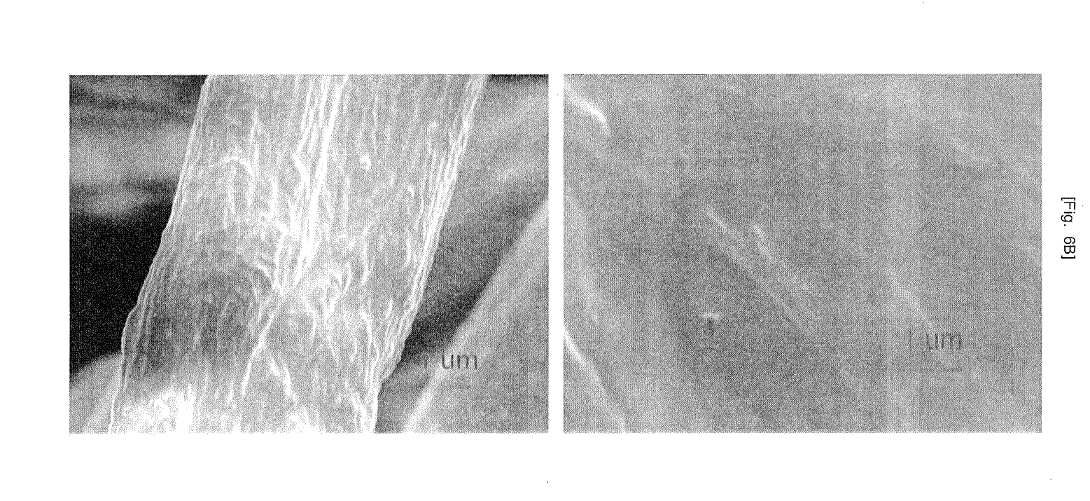

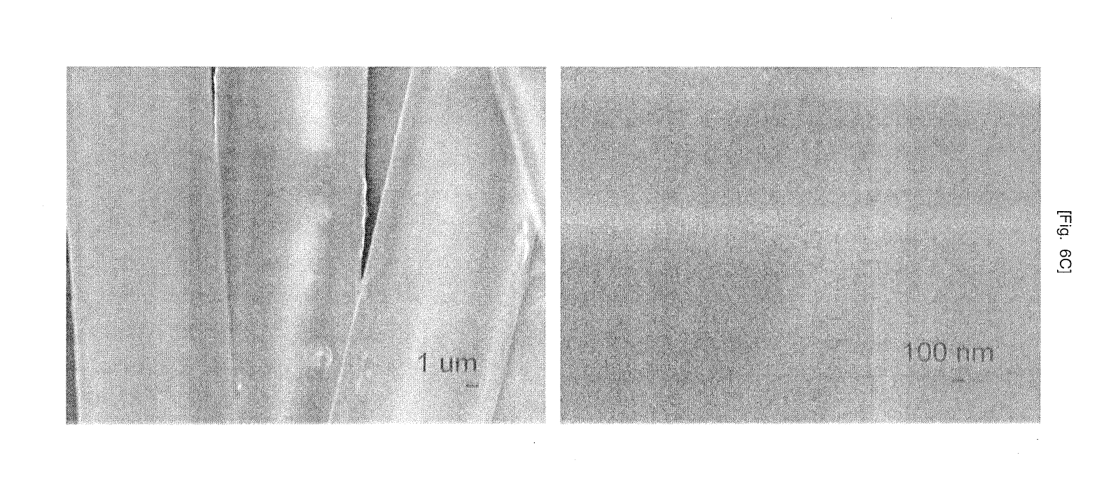

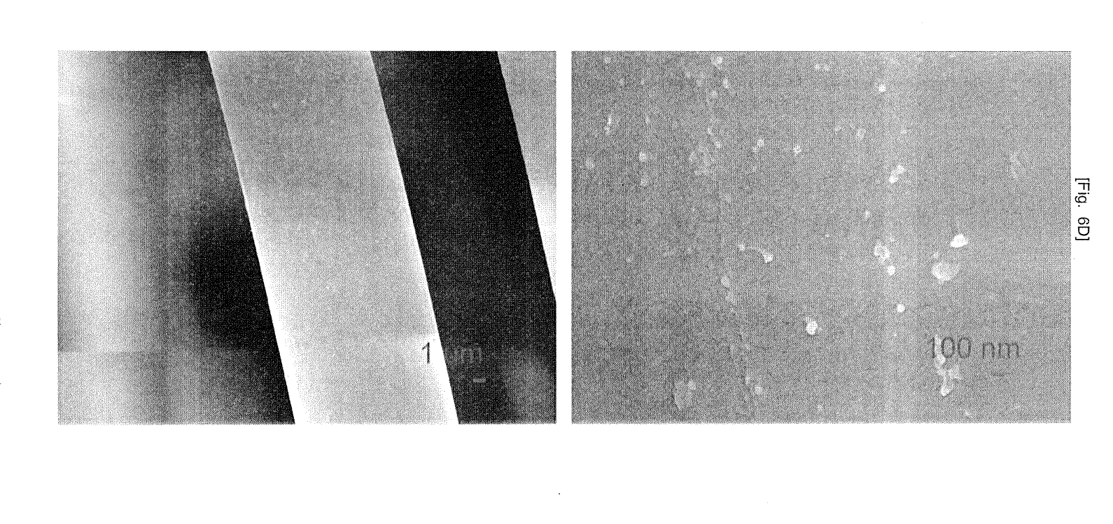

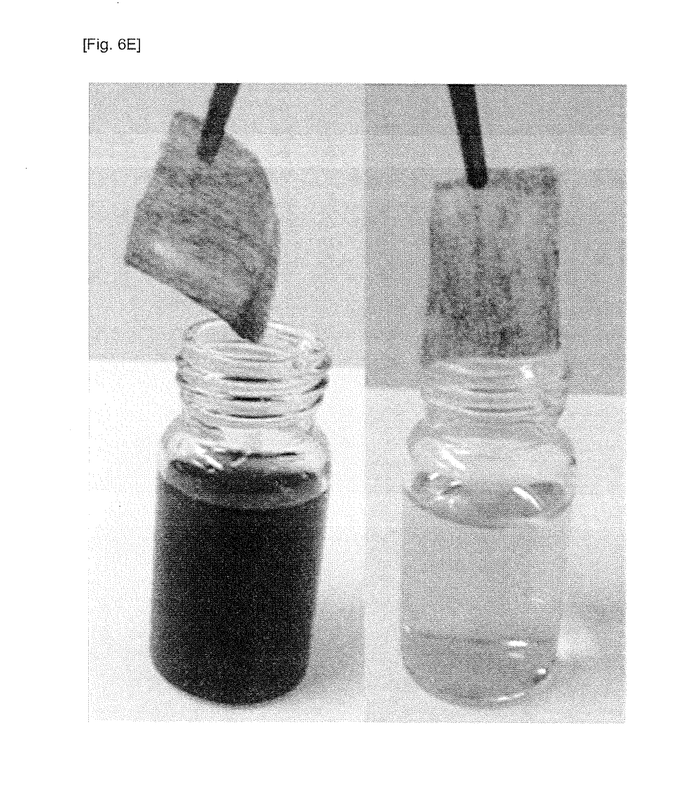

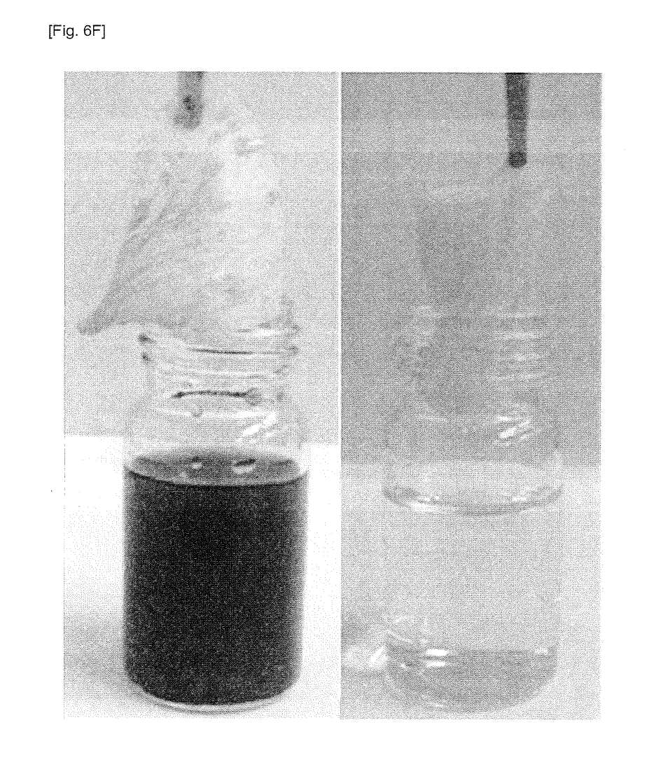

The prepared samples 1-4 and 6-7 were dispersed into chloroform and toluene solution, respectively, to form coating solutions. These coating solutions were directly applied onto the fabrics using dip-coating. After the fabric coating treatment, a significant change in hydrophobicity was observed. The contact angle and detailed morphology of various hybrid materials coated fiber tissue are indicated in FIG. 6.

The water contact angle measurement revealed that fabrics coated with polymer composites according to the present invention showed a nearly sphere-like water droplet with water contact angles of 145-160°. Such spherical droplets (10 μL) were stable and can maintain their spherical morphology on the fabrics for extended periods of time. For instance, the fabric coated with sample 1 (which corresponds to the lowest concentration of RGO, i.e., 0.026 wt % RGO) was surprisingly capable of improving the WCA from 51° to 145° when compared to a pure PDMS coating solution without addition of functionalized RGO.

The above observation is in contrast to the case of sample 6 where no high contact angle was observed, which may be due to its relatively shorter PDMS side chains (m.w. 400˜600). Note however that, no contact angle could be observed when pure water is dropped onto the un-coated fabrics, where the water completely spread into the fabric as shown in FIG. 6A. In contrast, a low contact angle can be observed by pure PDMS (no RGO) coated fabrics at the same concentration.

In a different control experiment, the coated fabrics were also stained with pigment-containing water for a stain resistance test. After being submerged into a stained solution, the fabrics coated with sample 3 was easily cleaned by rinsing with water (FIG. 6E). In contrast, the uncoated fiber tissue remain stained after washing.

The excellent stain resistance of the coating here suggests that it has significant potential for fabrics in anti-fouling of organic contamination applications. The comparison tests demonstrate that only a trace amount of RGO is required in obtaining superhydrophobic properties.

Moreover, in a different control experiment, the coating-dependent fibre morphology changes can be clearly observed by SEM images. Original un-coated fabrics possess a rather rough surface as shown in FIG. 6B.

Consistent with contact angle analysis, a set of distinct smooth shells inherit the original shape of the fabric weave observed by SEM images (FIG. 6C-D), which corresponds to coating layer of the PDMS@RGO hybrids. Although the boundary between the PDMS and RGO could not be seen due to the unconducive coating materials and a trace amount of RGO applied, the existence of RGO particles evenly distributed throughout the shells were observed in FIG. 6D. In comparison with coating on the glass slide, the coating materials take advantage of the inherent morphological anisotropy of fabrics which latter provides a hierarchical roughness in the micro scales to further enhance the surface hydrophobicity. Based on such superhydrophobicity features, a mechanism is proposed as depicted in FIG. 7, which combines the surface roughness and surface chemistry to mimic the hydrophobicity of lotus leaves.

Stability Testing

The long-term stability of the superhydrophobic coating in harsh environments and laundry conditions is important for practical application. As can be observed, water droplets are spherical with an average contact angle of 155° after immersing the coated fabrics in an aqueous H₂SO₄ solution (pH=1) and an aqueous KOH solution (pH=14) for the various time periods.

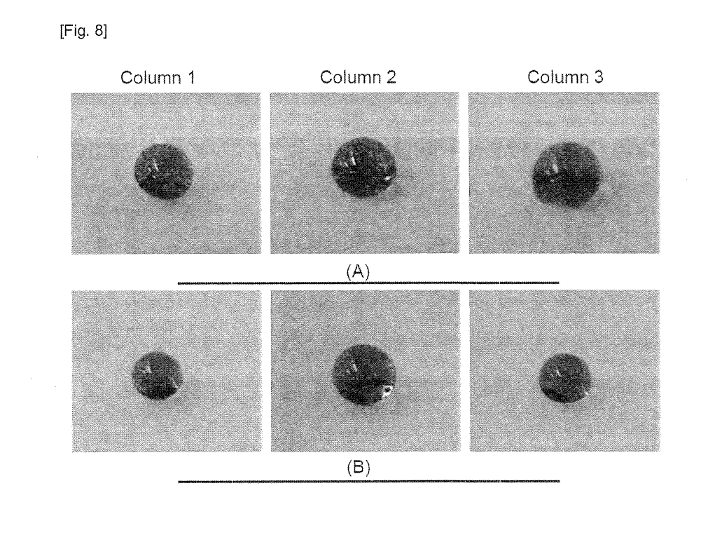

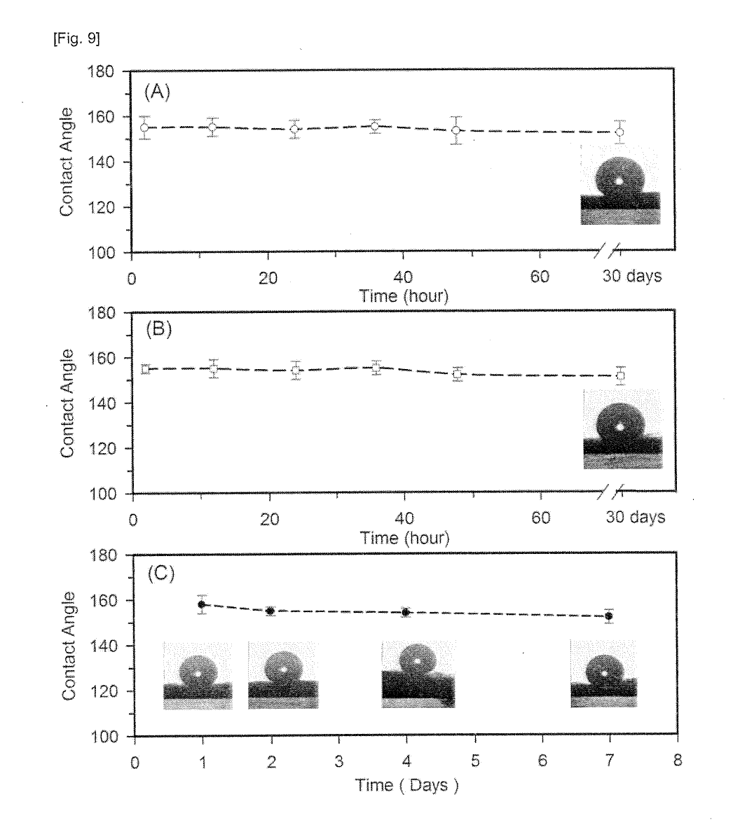

For example, the long-term etching performances of sample 3 at acidic and alkaline condition are displayed in FIGS. 8 and 9. The contact angle as a function of etching time provides a stable curve, suggesting the superhydrophobic fabric coating layer exhibited excellent resistance to both a strong acid and strong corrosive alkaline solutions. Furthermore, this type of superhydrophobic coating also showed good thermal stability to boiling water. Experimental results showed that the coated fabrics had no change in superamphiphobicity after boiling the coated fabrics in water for 2 h. In addition, the superhydrophobic stability of fabric coating in the laundry conditions was examined. As shown in FIG. 9A, the contact angle of a fabric coated with sample 3 showed only a slight decrease despite being subjected to a corrosive H₂SO₄ (pH 1) environment for 30 days.

As shown in FIG. 9C, the contact angles of textile fibers coated with sample 3 only slightly dropped but still remained more than 150° after being stirred in 500 mL water using an egg shaped stirring bar (TEFLON®, ¾×1⅝ in) at 900 rpm for one week.

The coating solution can be applied to various natural or man-made fibers, e.g. polyester, cotton, asbestos cloth et al, using the same dip-coating method to achieve similar superhydrophobicity. These results are comparable to the reported silica-assisted fluoro-polymer coating on fabrics. Typically, such coating materials for fabricating hierarchical fabrics structure with high thermal and acid/base stability holds great promise in offering a variety of applications in the areas of textile processing, packaging materials, paper industry, antifouling clothing, sportswear and boat sails.

Thus it can be seen that polymer composites disclosed in accordance with the present embodiments have the advantages of long-term hydrophobicity and which provide useful resistance against chemical attacks. While exemplary embodiments have been presented in the foregoing detailed description of the invention, it should be appreciated that a vast number of variations exist.

It should further be appreciated that the exemplary embodiments are only examples, and are not intended to limit the scope, applicability, operation, or configuration of the invention in any way. Rather, the foregoing detailed description will provide those skilled in the art with a convenient road map for implementing an exemplary embodiment of the invention, it being understood that various changes may be made in the function and arrangement of elements and method of operation described in an exemplary embodiment without departing from the scope of the invention as set forth in the appended claims.

1.-28. (canceled)

29. A polymer composite comprising a lattice of polycyclic aromatic hydrocarbons modified with at least one siloxane polymer.

30. The composite of claim 29, wherein the lattice of polycyclic aromatic hydrocarbons comprises graphene or wherein the graphene is reduced graphene oxide (“RGO”) or wherein the RGO is covalently coupled to said at least one siloxane polymer by a linker group.

31. The composite of claim 29, wherein the lattice of polycyclic aromatic hydrocarbons is functionalized with at least one functional group reactive with a silicon hydride group or wherein said functional group is alkenyloxy alkyl or an aryl substituted with an alkenyloxy or an alkenyl prior to modification with said siloxane polymer or wherein the alkenyloxy alkyl is vinyloxy alkyl or wherein the alkenyloxy aryl is vinyloxy benzyl.

32. The composite of claim 30, wherein the reduced graphene oxide is thermally reduced graphene oxide or chemically reduced graphene oxide.

33. The composite of claim 29, wherein the siloxane polymer is an organopolysiloxane polymer.

34. The composite of claim 33, wherein the organopolysiloxane polymer comprises hydrophobic groups selected from alkyl or aryl or wherein the hydrophobic alkyl group is a C₁₋₁₀-alkyl.

35. The composite of claim 33, wherein said organopolysiloxane polymer comprises the following formula (I): 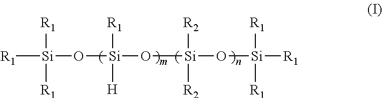
wherein
R₁, at each occurrence, is independently selected from hydrogen, an alkyl, an aryl or an alkylaryl;
R₂ is an alkyl;
m is 0 or an integer from 5 to 100; and
n is 0 or an integer from 9 to 500.

36. The composite of claim 35, wherein R₁ and R₂ are independently C₁₋₁₀-alkyl.

37. The composite of claim 35, wherein R1 is an aryl group.

38. The composite of claim 35, where n is 0.

39. The composite of claim 38, wherein said organopolysiloxane polymer has an average Mn of about 390 or having a range of about 1,700 to about 3,200.

40. The composite of claim 35, wherein m is 0.

41. The composite of claim 35, wherein the weight ratio of the siloxane polymer to the polycyclic aromatic hydrocarbon is in a range of about 20:1 to about 4000:1 or is from about 200:1 to about 3800:1.

42. A method for forming a polymer composite, comprising reacting a lattice of polycyclic aromatic hydrocarbons with at least one siloxane polymer.

43. The method of claim 42, further comprising functionalizing the lattice of polycyclic aromatic hydrocarbons with an unsaturated functional group capable of reacting with a silicon hydride group prior to said reaction with the siloxane polymer.

44. The method of claim 42, wherein the reaction operation is undertaken in the presence of a metal-containing catalyst, wherein the metal is selected from Groups 8, 9, or 10 of the Periodic Table of Elements or wherein said metal-containing catalyst comprises a metal selected from the group consisting of platinum, rhodium, ruthenium and alloys or mixtures thereof.

45. The method of claim 42, wherein the reacting operation comprises the addition of functionalized reduced graphene oxide to the siloxane polymer in a weight % of about 0.02% to 0.5% based on the weight of the siloxane polymer.

46. The method of claim 42, wherein the reacting operation is undertaken in an inert atmosphere and in the presence of a solvent.

47. A method of coating a material, comprising:
a) dissolving a polymer composite comprising a lattice of polycyclic aromatic hydrocarbons modified with at least one siloxane polymer in a solvent to form a coating solution;
b) immersing said material in the coating solution; and
c) removing said material from the coating solution.

48. The method of 47, further comprising an operation of (d) drying the material from operation (c) to remove the solvent.
